(19) United States
(12) Patent Application Publication
(10) Pub. No.: US 2025/0058342 A1
(43) Pub. Date: Feb. 20, 2025

(54) Atomizer Comprising an Air Supply Skirt and Method of Mounting Such a Skirt on a Main Body of Such an Atomizer

(71) Applicant: Exel Industries, Epernay (FR)

(72) Inventor: Denis Vanzetto, Epernay (FR)

(21) Appl. No.: 18/803,000

(22) Filed: Aug. 13, 2024

(30) Foreign Application Priority Data
Aug. 14, 2023 (FR) 2308700

(51) Int. Cl. B05B 12/18; B05B 3/10

(52) U.S. Cl. CPC B05B 12/18; B05B 3/1092

(57) ABSTRACT

The present invention relates to a coating product atomizer comprising a main body, an air supply skirt attached to the main body and magnetic attraction means between the magnetic body and the air supply skirt. The atomizer comprises a magneto-pneumatic or magneto-hydraulic system which includes a magnetic device for hooking the air supply skirt to the main body and a pneumatic or hydraulic mechanism for locking and clamping the air supply skirt to the main body.

### CROSS-REFERENCE TO RELATED APPLICATION

This application claims the benefit of FR 2308700 filed on Aug. 14, 2023, which is incorporated herein by reference in its entirety.

### BACKGROUND

The present invention relates to a coating product atomizer equipped with an air supply skirt which allows to distribute, close to a spray member of the atomizer, a flow of air for guiding or shaping a cloud of coating product droplets leaving the spray member. This spray member may be a rotating bowl or a magnetic spray head.

It is known to mount an air supply skirt on the main body of an atomizer by screwing. This technique requires screwing notches to be arranged on the outside of the air supply skirt, so that a tool can exert a screwing or unscrewing torque. These notches are potential accumulation areas for the coating product, leading to the risk of soiling the atomizer or coated surfaces. In addition, tightening the skirt to the atomizer body is relatively slow and requires a tool, such as a dynamometer, to check that the torque exerted is sufficient to ensure an airtight seal between the air supply skirt and the rest of the atomizer. Finally, screwing must most often be carried out manually, to the extent that automating the method of changing the air supply skirt proves very complex in practice.

Some of these problems have been solved by the atomizers described in EP3222360A1 and US2017/266672A1, each of which discloses a coating product atomizer equipped with magnetic attraction means between an air supply skirt and a fixed member. This solution is generally satisfactory. However, the force required to seal the mounting of the air supply skirt on an atomizer body are considerable, particularly for compressing the seals arranged at the interface between the air supply skirt and the main atomizer body. As a result, strong magnets have to be used, and the force exerted is intense and therefore potentially dangerous, particularly in the event of a finger of a user or a tool carried by the user becoming trapped. In addition, the intensity of the magnetic force is such that, in practice, specific tools have to be used to dismantle the air supply skirt during a maintenance operation.

### SUMMARY

It is these drawbacks that the invention more particularly aims to remedy by proposing a new coating product atomizer in which mounting an air supply skirt onto a main body is made easier and safer for the operator, this mounting being, to a large extent, automated.

To this end, the invention has as its object, a coating product atomizer comprising a main body, an air supply skirt attached to the main body and magnetic attraction means between the magnetic body and the air supply skirt, characterized in that the atomizer comprises a magneto-pneumatic or magneto-hydraulic system which includes
a magnetic device for hooking the air supply skirt onto the main body; and
a pneumatic or hydraulic mechanism for locking and clamping the air supply skirt to the main body.

Thanks to the invention, the magneto-pneumatic or magneto-hydraulic system of the atomizer allows to exert, in a first stage, a magnetic force to hook the air supply skirt onto the main body and then, in a second stage, a mechanical force to clamp the air supply skirt onto the main body, which, in particular, allows the seals arranged between the skirt and the main body to be compressed. This two-stage operation means that the magnetic force exerted by the magnetic device is relatively low, making it less dangerous for a user to handle the air supply skirt when it is mounted on the main body. The fact that this magnetic force is relatively low makes it easier to remove the air supply skirt relative to the main body. In addition, this relatively low magnetic force and the automatable nature of the magneto-pneumatic or magneto-hydraulic system make the atomizer compatible with a method of mounting or dismantling the air supply skirt on the atomizer main body by means of a robot.

According to advantageous but non-mandatory aspects of the invention, such an atomizer may incorporate one or more of the following features according to any technically permissible combination:
The magnetic hooking device is configured to exert, between the air supply skirt and the main body, an axial magnetic force, parallel to a longitudinal axis of the atomizer, with a first intensity, the pneumatic or hydraulic clamping mechanism is configured to exert between the air supply skirt and the main body an axial mechanical force, parallel to the longitudinal axis of the atomizer, with a second intensity and the second intensity is strictly greater than the first intensity.
The atomizer comprises seals arranged between the air supply skirt and the main body, and the seals compressed by the mechanical force exerted by the pneumatic or hydraulic clamping mechanism isolate the shaping air flow ducts arranged in the main body and in a body of the air supply skirt from the outside of the atomizer.
The air supply skirt comprises a sleeve made of ferromagnetic material, centered on a longitudinal axis of the atomizer in the mounted configuration of the air supply skirt on the main body, and provided with at least one external relief for cooperation with the pneumatic or hydraulic clamping mechanism.
The magnetic hooking device comprises a permanent magnet mounted on a support, movable parallel to the longitudinal axis of the atomizer, and the permanent magnet or the support is configured to receive in abutment one end of the sleeve opposite a skirt body.
The pneumatic or hydraulic clamping mechanism comprises a piston, movable parallel to the longitudinal axis of the atomizer, inside a chamber selectively supplied with pressurized fluid, and the piston is equipped with members for engaging with the external relief of the sleeve.
The engagement members are balls, the piston comprises cam surfaces inclined relative to the longitudinal axis of the atomizer and, when the air supply skirt is hooked onto the main body by the magnetic hooking device and when the piston is displaced in the direction of one end of the sleeve opposite a body of the air supply skirt, the cam surfaces exert, on the balls, an engagement force in the external relief of the sleeve, this force being centripetal relative to the longitudinal axis.
The atomizer comprises at least one elastic member for returning the piston toward a position in which the engagement members are disengaged from the external relief of the sleeve.
The atomizer comprises a tool for dismantling the air supply skirt, this dismantling tool comprising hooking reliefs on the air supply skirt and being configured to exert on the air supply skirt a force parallel to a longitudinal axis of the atomizer and opposite to a magnetic force exerted on the air supply skirt by the magnetic hooking device.

According to a second aspect, the invention has as its object a method of mounting an air supply skirt onto a main body of a coating product atomizer such as mentioned above, characterized in that it comprises at least successive steps consisting of:
a) introducing a sleeve of the air supply skirt into a central housing of the main body until the magnetic hooking device exerts a magnetic hooking force on the air supply skirt on the main body; and
b) supplying the pneumatic or hydraulic clamping mechanism with pressurized fluid until the pneumatic or hydraulic clamping mechanism exerts a mechanical force to clamp the air supply skirt to the main body.

Advantageously, the atomizer, during step b), the piston displaces the balls toward a bottom of the central housing, driving the sleeve with the balls engaged in the external relief.

### BRIEF DESCRIPTION OF THE DRAWINGS

The invention will become clearer on reading the following description, which is given solely by way of non-limiting example and is made with reference to the appended drawings wherein:

FIG. 1 is a partially exploded longitudinal cross-section of an atomizer in accordance with a first embodiment of the invention;

FIG. 2 is an exploded perspective longitudinal cross-section of a magneto-pneumatic system belonging to the atomizer of FIG. 1;

FIG. 3 shows, on two inserts A) and B), the atomizer of FIG. 1 during a first step of mounting an air supply skirt on a main body, insert B) being a larger scale view of detail B on insert A);

FIG. 4 is a view similar to FIG. 3, during a second step of the method of mounting;

FIG. 5 is a view similar to FIG. 3, during a third step of the method of mounting;

FIG. 6 is a view similar to FIG. 3, during a fourth step of the method of mounting;

FIG. 7 is a perspective view of the atomizer of the skirt in the mounted state on the main body, as well as a skirt dismantling tool;

FIG. 8 is a perspective axial cross-section of the atomizer shown in the previous figures, while the skirt is being dismantled;

FIG. 9 is a section similar to FIG. 1, for an atomizer in accordance with a second embodiment of the invention; and

FIG. 10 is a view similar to FIG. 1, for an atomizer in accordance with a third embodiment of the invention.

### DETAILED DESCRIPTION

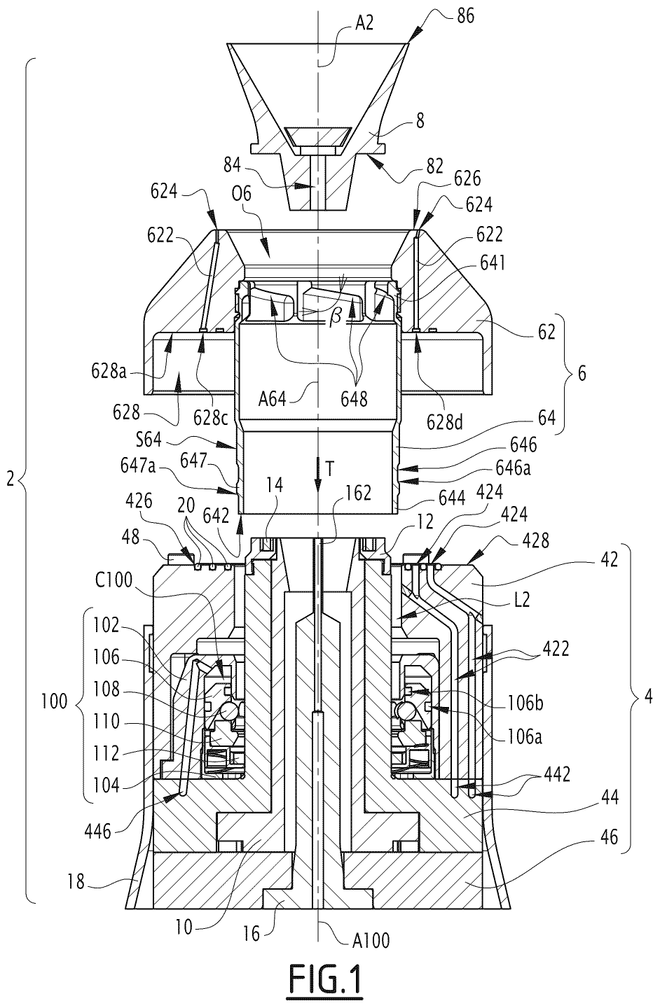

The coating product atomizer 2 shown in FIGS. 1 to 8 comprises a main body 4 formed by the assembly of an external part 42, an internal part 44 and a base 46.

For example, the coating product is a liquid paint, primer or varnish intended for application to a motor vehicle body or component.

Screws 48 secure the parts 42, 44 and 46 of the main body. These screws 48 protrude relative to a front face 428 of the outer part 42.

The atomizer 2 is of the internally charged electrostatic type and comprises a high-voltage unit, not shown, configured to raise to a given electrical potential the coating product sprayed by the atomizer 2.

The longitudinal axis of the atomizer 2 is noted A2.

A front side of the atomizer 2 or a component thereof is defined as a side turned toward a part to be coated, when the atomizer 2 is in use, and a rear side as a side turned away from the front side. In the figures, the front of the atomizer 2 is turned upward and the rear is turned downward.

An air supply skirt 6 is mounted on the main body 4 in the assembled configuration of the atomizer 2. This air supply skirt 6 comprises a skirt body 62 and a sleeve 64 screwed onto the skirt body 62.

Alternatively, the skirt body 62 and the sleeve can be secured together by crimping, welding and/or bonding.

The secure connection between the skirt body 62 and the sleeve 64 is made at a front end 641 of the sleeve.

The sleeve 64 is made of a ferromagnetic material, for example, steel.

A spray bowl 8 also belongs to the atomizer 2 and is intended to be driven in rotation, about the longitudinal axis A2, by a turbine the rotor of which is noted 10. The stator of the turbine is constituted by the internal part 44 of the main body 4 and carries an end piece 12 equipped with an annular permanent magnet 14.

In the mounted configuration of the bowl 8 on the turbine rotor 10, an annular surface 82 of the bowl 8, which is made of a ferromagnetic material, comes to face the permanent magnet 14, the effect of which creates a magnetic bearing between the bowl 8 and the magnet 14, when an air flow is directed between the magnet 22 and the annular surface 82.

Alternatively, only part of the bowl 8 defining the annular surface 82 is made of ferromagnetic material.

The atomizer 2 also comprises a coating product injector 16, the downstream end 162 of which penetrates into a central bore 84 of the bowl 8, in the mounted configuration of the bowl on the rotor of the turbine 10.

A cover 18 is mounted about the main body 4, protecting it from the sprayed coating product.

The skirt body 62 is equipped with a number of channels 622 which pass right through it, according to a direction parallel to the longitudinal axis A2, in the mounted configuration of the air supply skirt 6 on the main body 4, and which each feed an outlet orifice 624 through which the air jets can be directed toward a cloud of coating product leaving an edge 86 of the bowl 8, in order to shape this jet of coating product and/or direct it toward an object to be coated. The orifices 624 are arranged on a circular front face 626 of the skirt body 62.

The skirt body 62 defines a recessed housing 628 in which a front portion of the external part 42 of the main body 4 is received in the mounted configuration of the air supply skirt 6 on the main body 4. The recessed housing 628 is located at the rear of the skirt body 62.

The external part 42 of the main body 40 comprises ducts 422 for conveying air toward the air supply skirt 6. These ducts 422 are supplied with air by the ducts 442 which extend essentially in a different plane to that shown in FIGS. 1 and 3 to 6, and of which only the downstream ends are visible in these figures.

The bottom 628a of the recessed housing 628 is equipped with two annular grooves 628c and 628d, which act as distributors to feed two groups of ducts 622 from the outlets 424 of the ducts 422. To ensure airtightness between the ducts 422 and the grooves 628c and 628d, the O-rings 20 are arranged in the annular grooves 426 on the front face 428 of the external part 42 of the main body 4, in other words, in an interface zone between the main body 4 and the skirt 6. These O-rings 20 are intended to bear against the bottom 628a of the recessed housing 628 and to be compressed.

In the example in the figures, the O-rings 20 and the annular grooves 426 are concentric and three in number. In an alternative, not shown, the number and/or shape of the O-rings 20 and annular grooves 426 are different.

The sleeve 64 is provided to be engaged in a central housing L2 of the atomizer 2 which is defined, radially to the longitudinal axis A2, between the external part 42 and the internal part 44 of the main body 4.

The rear edge of the sleeve 64 is noted 642, in other words, the edge of this sleeve opposite the skirt body 62. The end of the sleeve 64 closest to the rear edge 642 is noted 644. The rear edge 642 delimits the rear end 644 opposite the skirt body 62. The rear end 644 is opposite the front end 641 of the sleeve 64.

The external radial surface of the sleeve 64 is noted S64. This external radial surface is provided with a peripheral groove 646 which forms a recessed housing on the outside of the sleeve 64. The rear edge of the peripheral groove 646 is noted 646a, in other words, the edge of this groove closest to the end 644 of the sleeve 64.

An outer peripheral rib on sleeve 64 is noted 647, which separates the peripheral groove 646 from the end 644. The trailing edge of this rib is noted 647a, in other words, the edge of this rib closest to the end 644 of the sleeve 64.

A magneto-pneumatic system 100 is provided in the central housing L2 to ensure the hooking of the skirt 6 onto the main body 4, as well as clamping this skirt onto this main body. The magneto-pneumatic system 100 comprises a magnetic hooking device 100A as well as a pneumatic clamping mechanism 100B for clamping the air supply skirt 6 to the main body 4.

Hooking, obtained by means of the magnetic hooking device 100A allows to ensure that the air supply skirt 6 remains in position on the main body 4, even when the latter is displaced by a multi-axis robot or a reciprocator on which the atomizer is mounted. The displacements of the atomizer induces accelerations on the air supply skirt 6, which could have the effect of pushing the sleeve 64 out of the central housing L2. The magnetic hooking force is dimensioned to resist these accelerations.

The clamping force allows to finalize the positioning of the air supply skirt 6 on the main body 4 and to compress the O-rings 20, therefore, to ensure the seal of the circuit supplying the outlet orifices 624 with air for shaping the cloud of coating product.

The magneto-pneumatic system 100 extends along a longitudinal axis A100 which coincides with the longitudinal axis A2 of the atomizer 2 in the mounted configuration of the magneto-pneumatic system 100 in the atomizer 2.

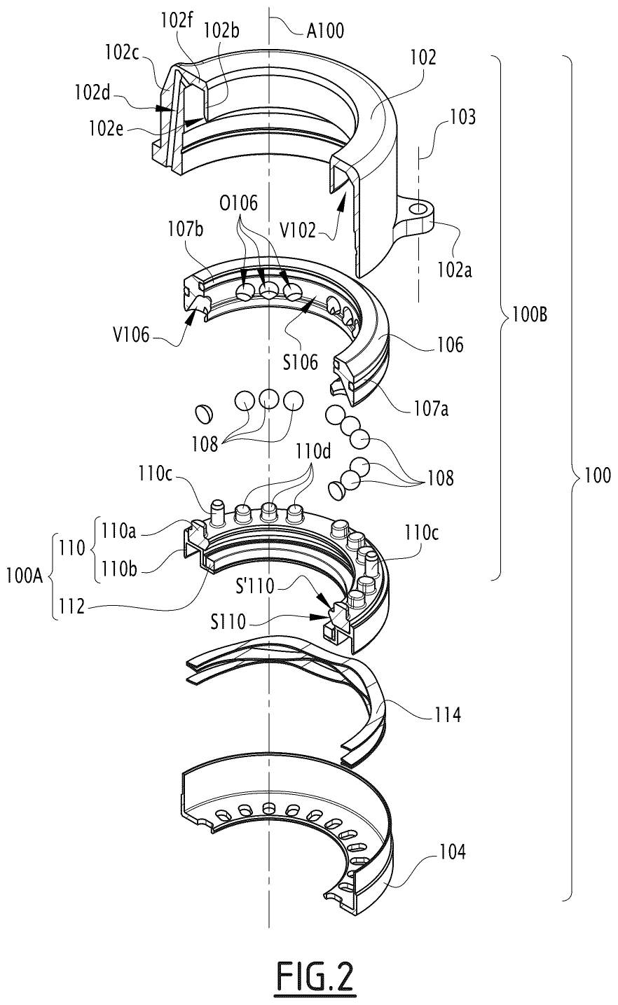

The magneto-pneumatic system 100 comprises a cover 102 immobilized on the main body 4 by screws which pass through one or more lugs 102a provided on the outside of the cover 102. One of these screws is represented by its axis line 103 in FIG. 2.

The cover 102 defines an annular volume V102 centered on the longitudinal axis A100 and bordered by an internal radial wall 102b and an external radial wall 102c.

A passage 102d is arranged in the thickness of the external radial wall 102c and allows a duct 446 arranged in the internal part 44 of the main body 4 to be fluidly connected to the volume V102.

On the other hand, the inner wall 102b of the cover 102 ends in a chamfered edge 102e turned toward the volume V102 and converging toward the longitudinal axis A100 opposite the bottom 102f of the volume V102, in other words, in the direction of the rear of the cover 102.

The magneto-pneumatic system 100 also comprises a cup 104 placed on the rear bottom of the central housing L2. In the example in the figures, the bottom of the central housing L2 is opposite its front mouth and delimited by the internal part 44.

The magneto-pneumatic system 100 also comprises an annular piston 106 equipped with two sealing segments 107a and 107b. In the example, the sealing segments are formed by two O-rings received in two peripheral grooves 106a and 106b, external and internal respectively, arranged on the piston 106. The O-rings 107a and 107b are not represented in FIG. 1, which allow the grooves 106a and 106b to be seen more clearly.

Alternatively, the sealing segments are formed by lip seals. According to another alternative, they are mounted on the walls of the cover 102 facing the piston 106.

The piston 106 is movable parallel to the coincident axes A2 and A100, being partially engaged in the volume V102 of the cover 102. As a result of the partial engagement of the piston 106 in the volume V102 and the carrying of the sealing segments 107a and 107b against the walls 102c and 102b, a sealed chamber of variable volume C100 is defined between the elements 102 and 106. This variable volume chamber C100 is supplied with pressurized air from the duct 446 through the passage 102d. Means, not shown, such as a source of pressurized air, a proportional valve and a bleed valve, allow the variable volume chamber C100 to be supplied with pressurized air or vented to atmosphere, depending on a sequence of mounting or dismantling of the skirt 6 on the main body 4. The air pressure present in the duct 446 is controlled independently of the air pressure driving the rotor 10 and the skirt air pressure in the ducts 442.

Alternatively, a part of the air for driving the rotor 10 can be diverted toward the duct 446. In this case, the variable volume chamber C100 can be supplied with pressurized air as soon as the turbine is operational. According to another alternative, the duct 446 can be supplied with pressurized air from air used in the atomizer 2 for another function, for example from the skirt air circulating in the ducts 442.

The piston 106 also defines the volumes V106 for receiving the balls 108, which constitute the members for engaging the piston 106 with the external peripheral groove 646 of the sleeve 64.

Advantageously, a ball 108 is mounted in each volume V106.

Each ball 108 is received in a volume V106 from which it may or may not protrude through an opening O106 which constitutes the outlet of each volume V106 onto the internal peripheral surface S106 of the piston 106.

Each volume V106 is defined, on its side opposite its opening O106, by a surface S106 converging toward the front in the direction of the longitudinal axis A100 and inclined relative to this longitudinal axis by an angle α, non-zero, preferably between 15° and 60°, more preferably between 30° and 50°.

The surfaces S106 of the various volumes V106 constitute the cam surfaces for guiding the balls 108.

The magneto-pneumatic system 100 also comprises a support 110 which is also annular in shape, centered on the longitudinal axis A100, and is formed by a solid body 110a and a profile 110b, both made of ferromagnetic material. The parts 110a and 110b of the support 110 are securely fastened together by any suitable means, in particular by gluing, crimping and/or welding.

Alternatively, the support 110 can be made in one piece.

The support 110 is equipped with pins 110c for indexing the position, about the longitudinal axis A100, opposite the piston 106.

The support 100 is also equipped with stops 110d intended to engage in the volumes V106 from the rear of the piston 106, to hold the balls 108 in position in these volumes.

The support 100 carries an annular permanent magnet 112 which is arranged on the radial internal side of the support 100. In the example, the permanent magnet is securely attached to the profile 110b, for example by adhesive bonding.

On the other hand, the support 100, more particularly its body 110a, defines a first internal frustoconical surface S110, centered on the longitudinal axis A100 and converging in the direction of the piston 106, and a second internal frustoconical surface S′110, centered on the longitudinal axis A100 and diverging in the direction of the piston 106.

The magneto-pneumatic system 100 also comprises a flat spring 114 which forms an elastic member for returning the piston 106, and preferably the support 110, toward the front. The flat spring 114 is formed by a steel leaf. The use of a flat spring such as the one shown in the figures presents the advantage of allowing a relatively large axial stroke of the piston 106, while the axial space requirement of the spring 114 is minimal.

Alternatively, the flat spring 114 can be replaced by another elastic member, in particular a block of elastomer or a spiral spring.

A method of mounting the skirt 6 on the main body 4 is now explained.

This is achieved by an axial movement in translation of the skirt 62, parallel to the longitudinal axis A2. This axial movement in translation is represented by the arrow T in FIGS. 1 and 3 to 6. No other movement of the air supply skirt 6 is required to mount it on the main body 4.

Thus, mounting of the air supply skirt 6 on the main body 4 results exclusively from a relative movement in translation between these components of the atomizer 2.

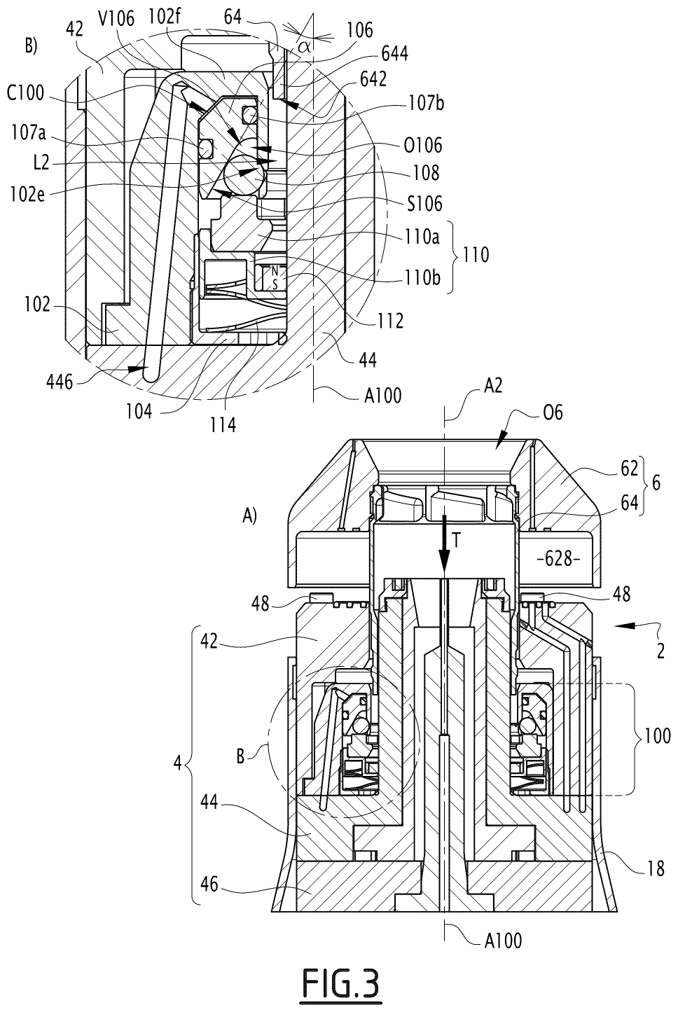

In a preliminary step represented in FIG. 1, the air supply skirt 6 is aligned with the axis A2 and brought closer to the main body 4 to reach the position shown in FIG. 3, which represents a first step in the method of mounting. In this step, the rear end 644 of the sleeve 64 is engaged in the central housing L2, without coming into contact with the components of the magneto-pneumatic system 100.

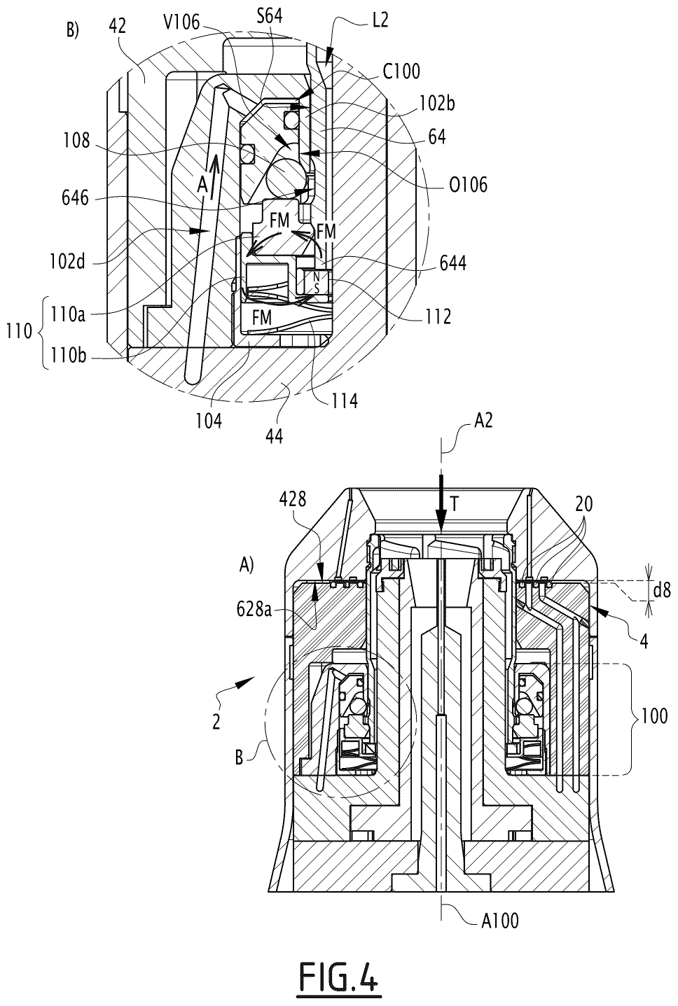

Continued mounting of the skirt 6 on the main body 4 brings the sleeve 64 to the step shown in FIG. 4, where its rear end 644 is bearing, by its edge 642, against the permanent magnet 112, while the edge 647a is bearing against the surface S′110, thus avoiding plastic deformation of the end 644 at the end of the stroke.

In this step, a closed magnetic flux FM is established through the rear end 644 of the sleeve 64, through the parts 110a and 110b of the support 110 and through the magnet 112, which has the effect of securing, by means of an axial magnetic force of attraction, the air supply skirt 6 to the support 110, which is held in position in the central housing L2 as it is limited in its movement between the cover 102 and the cup 104. The axial magnetic force of attraction between the parts 12 and 64 is parallel to the longitudinal axis A2, preferably centered on this axis, and results in the air supply skirt being hooked onto the main body. This force is therefore a hooking force of these parts together.

The permanent magnet 112 is chosen to exert on the sleeve 64 a magnetic hooking force of sufficient intensity to hold the air supply skirt 6 in position on the main body 4, even when the latter is displaced, for example when it is mounted on the wrist of the arm of a multi-axis robot or on a reciprocator, thus subjecting the air supply skirt to these accelerations potentially directed in a direction of extraction of the sleeve 64 relative to the central housing L2. In practice, the magnetic hooking force exerted by the permanent magnet on the sleeve has an intensity 11 of between 10 and 20 daN, preferably of the order of 15 daN, which allows effective hooking of the air supply skirt 6 onto the main body 4. On the other hand, the relatively moderate value of this intensity 11 of the magnetic hooking force limits the risk of injury, by pinching, to an operator when the latter presents the air supply skirt 6 and engages the sleeve 64 in the central housing L2.

In the step shown in FIG. 4, the air supply skirt 6 is hooked onto the main body 4 thanks to the magnetic force, but the bottom 628a of the recessed housing 628 remains away from the front face 428 of the external part 42 by a non-zero axial distance d8, this distance d8 being measured parallel to the longitudinal axis A2. In particular, in this step, the seals 20 are not compressed and the seal between the air circuits, formed by the ducts 422 and 622 and the grooves 628c and 628d, is not ensured vis-a-vis the outside.

In the steps shown in FIGS. 1, 3 and 4, the spring 114 exerts a force, on the support 110, to move it away relative to the cup 104, which has the effect of engaging the stops 110d in the various volumes V106, to the point where these stops 110d bear on the balls 108, which in turn bear on the cam surfaces S106 of the piston 106, which has the effect of pushing the latter toward the bottom 102f of the volume V102. The variable volume chamber C100 then has a minimum volume, visible in particular in insert B) of FIG. 3.

In this position, each ball 108 bears against the chamfered edge 102e of the cover 102, so that it is held in position in the corresponding volume V106 without projecting radially from the wall 102b, according to a direction radial to the longitudinal axis A100 and centripetal. Under these conditions, the balls 108 do not impede the sliding of the sleeve 64 in the central housing L2, particularly during the sequence of steps shown in FIGS. 1, 3 and 4. In particular, in the step shown in FIG. 4, the balls 108 are not engaged in the external peripheral groove 646.

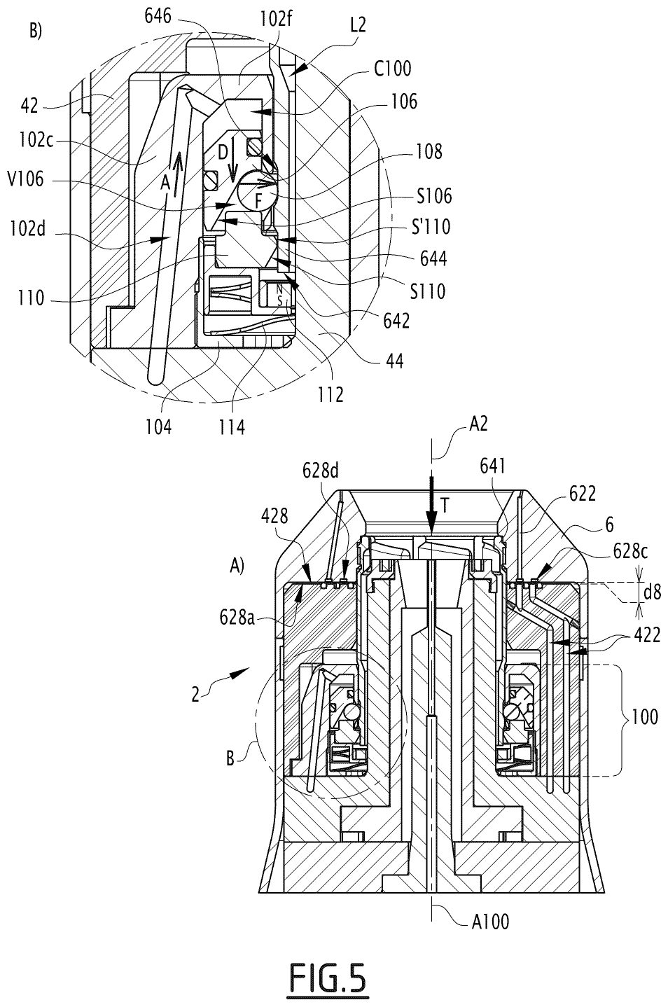

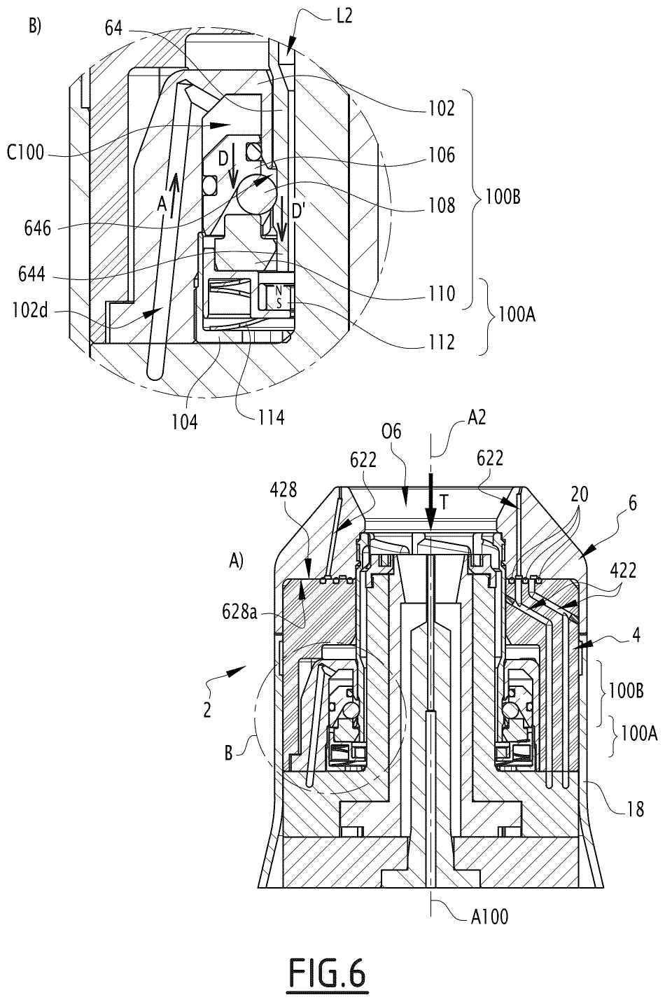

From the step in FIG. 4 onward, the passage 102d is supplied with pressurized air, which is represented by the arrow A in FIGS. 4 to 6. This has the effect of pressurizing the variable volume chamber C100, which expands, in other words, dilates in the direction of the cup 104, as can be seen by comparing FIGS. 4 and 5. This axial expansion of the chamber C100 results from an axial displacement, parallel to the longitudinal axis A2, of the piston 106 in the direction of the cup 104, represented by the arrow D in FIGS. 5 and 6, this displacement being due to the difference between the pressure prevailing inside the variable volume chamber C100 and the external atmospheric pressure.

This displacement D of the piston 106 has the effect of displacing in the direction of the cup 104, therefore the bottom of the central housing L2, the various balls 108 which then become offset relative to the chamfered edge 102e of the wall 102b, this edge then no longer opposing a centripetal radial movement of the balls 108 through the openings O106. However, given the inclined nature of the cam surfaces S106 of the different volumes V106, the displacement of the piston 106 in the direction of the cup 104 has the effect of exerting a centripetal force relative to the longitudinal axis A2 on the different balls 108, represented by the arrow F in FIG. 5 and directed toward the external peripheral groove 646. Thus, the air supply to the chamber C100 allows the various balls 108 to be tightened around the sleeve 64, engaging them, in other words, causing them to penetrate at least in part, into the external peripheral groove 646. The balls 108 thus constitute the members for engaging the piston 106 with the external relief of the sleeve 64 constituted by the peripheral groove 646.

In the sequence of steps in FIGS. 4 and 5, the balls 108 push the support 110 in the direction of the cup 104, against the elastic force exerted by the spring 114, which has the effect of axially separating the spring 112 and the end 644 of the sleeve 64. In other words, in the step in FIG. 5, the rear edge 642 of the sleeve 64 no longer bears against the magnet 112, and the edge 647a no longer bears against the surface S′110. This is not a problem, since the balls 108 engaged in the external peripheral groove 646 effectively retain the sleeve 64 in the central housing L2.

At the end of the step in FIG. 5, the value of the distance d8 has decreased relative to its value in the step in FIG. 4 but remains non-zero.

The continued supply of pressurized air to the variable volume chamber C100 through the passage 102d has the effect of continuing the displacement of the piston 106 in the direction of the cup 104, against the elastic force exerted by the spring 114, in the direction of the arrow D in FIG. 6. During this displacement, the balls 108 come to bear against the rear edge 646a of the external peripheral groove 646 and transmit to the sleeve 64 the displacement force they undergo as a result of the movement of the piston 106 in the direction of the arrow D. Thus, the sleeve 64 is displaced at the same time and over the same stroke as the piston 106, in the direction of the bottom of the central housing L2, which is represented by the displacement arrow D′ in FIG. 6.

This displacement D′ of the sleeve 64 inside the central housing L2 has the effect of firmly pressing the bottom 628a of the recessed housing 628 against the front face 428 of the external part 42 of the body 4, compressing the seals 20, thereby fluidly isolating the ducts 422 and 622 and the grooves 628c and 628d from the outside. In other words, the pneumatic mechanism 100B exerts, on the sleeve 64 and by means of the balls 108, an axial mechanical clamping force, parallel to the longitudinal axis A2, which firmly presses the bottom 628a of the recessed housing 328 of the air supply skirt 6 against the front face 428.

Thus, the placing and securing of the air supply skirt 6 on the main body 4 is carried out in two stages thanks to the magneto-pneumatic system 100. The pneumatic mechanism 100B is therefore also a mechanism for locking the air supply skirt 6 to the main body 4.

The mechanical hooking device 100A, which comprises the elements 110 and 112, allows to hold the air supply skirt 6 in position on the body 2 before the pneumatic clamping mechanism 100B, which comprises the elements 102, 106, 108 and 110, is used by supplying the variable volume chamber C100 with pressurized air to effectively clamp the air supply skirt 6 in place on the main body 4, in particular by compressing the seals 20. The cup 104 and the spring 114 are accessories to the mechanical hooking device 100A and the pneumatic clamping mechanism 100B within the magneto-pneumatic system 100.

The mechanical clamping force obtained by means of the pneumatic clamping mechanism 100B has an intensity 12 strictly greater than the intensity of the magnetic force mentioned above.

For example, the mechanical force obtained with the pneumatic clamping mechanism 100B can have an intensity of between 80 and 200 daN, preferably between 100 and 150 daN, even more preferably of the order of 120 daN.

A method of mounting the air supply skirt 6 on the main body 4 comprises two main steps, namely
The fact of inserting the sleeve 64 into the central housing L2 until the rear edge 642 comes into contact with the permanent element 112, allowing the magnetic hooking device 100A to exert the hooking force required to attach the air supply skirt 6 to the main body 4, resulting from the magnetic flux FM represented in FIG. 4;
The fact of supplying pressurized air to the variable volume chamber C100 of the pneumatic clamping mechanism 100B, as shown by arrow A, which has the effect of moving the piston 106 and the sleeve 64, respectively in the direction of the arrows D and D′ in FIG. 6, and clamping the air supply skirt 6 to the main body 4, in particular compressing the seals 20.

When it is time to dismantle the skirt 6 relative to the main body 4, the supply of pressurized air to the variable volume chamber C100 is stopped and the passage 102d is vented. The spring 114 then pushes the support 110, the balls 108 and the piston 106 toward the bottom 102f of the volume V102, reducing the volume of the variable volume chamber C100.

The balls 108 then come into abutment against the chamfered edge 102e of the wall 102b, which has the effect of sending them back toward the interior of the volumes V106, extracting them from the external peripheral groove 646. In other words, the balls 108 are no longer engaged with the external peripheral groove 646. Thus, the elastic force exerted by the spring 114 tends to return the piston to a position in which the balls 108 can be disengaged from the external peripheral groove 646 of the sleeve 64.

By being pushed back by the spring 114, the support 110 drives with it the magnet 112, which comes into contact with the rear edge 642 of the sleeve 64, which has the effect of reactivating the magnetic hooking force between the sleeve 64 and the magnet 112. The magneto-pneumatic system 100 is then in a configuration similar to that in FIG. 4, where the seals 20 are no longer compressed and the air supply skirt 6 remains hooked onto the main body 4 by the magnetic force resulting from the magnetic flux FM represented by the arrows F. The air supply skirt 6 is reliably retained on the main body 4, for the reasons explained above.

It is then possible to extract the air supply skirt 6 by exerting an axial force in a direction opposite to that of the arrow T in FIGS. 1 and 3 to 6.

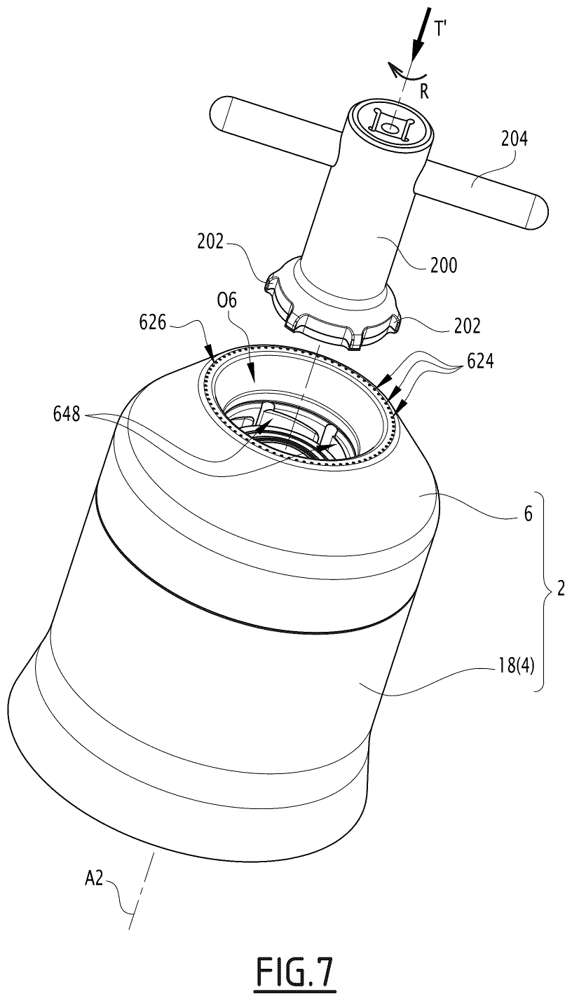

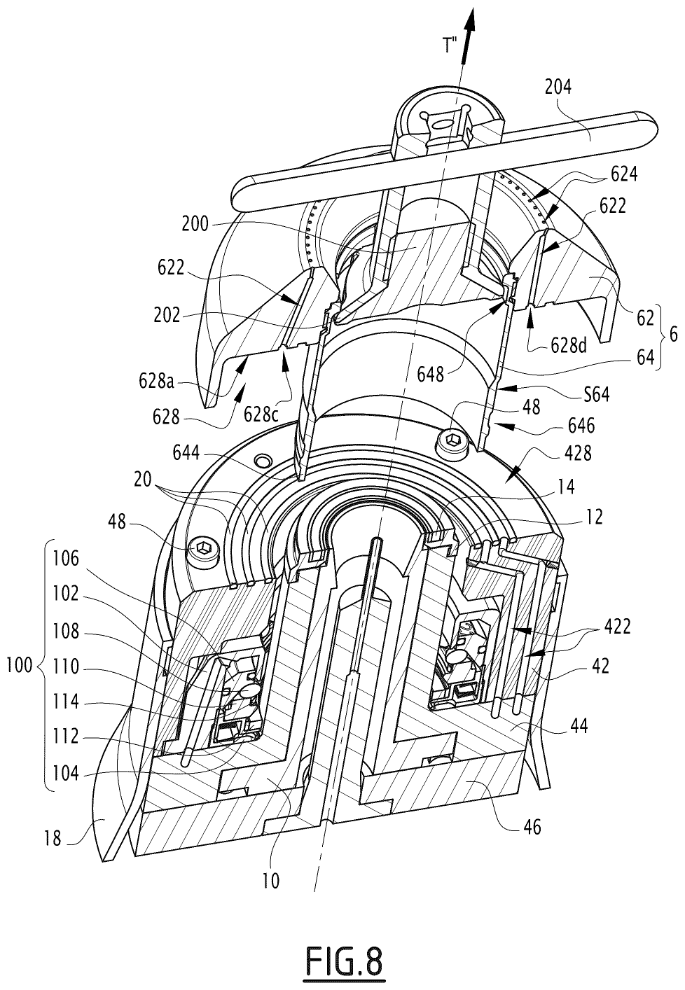

In this respect, it is possible to use a dismantling tool 200 visible in FIGS. 7 and 8, which forms part of the atomizer 2, in that it is included in the supply of this atomizer when it is installed on a coating product application site, and which is provided with teeth 202 for hooking onto the internal reliefs 648 of the sleeve 64, provided at its front end 641. The reliefs 648 are inclined relative to a longitudinal axis A64 of the sleeve 64, by an angle β, non-zero, for example between 45 and 70°. The longitudinal axes A2, A64 and A100 coincide in the mounted configuration of the air supply skirt on the main body 4.

The dismantling tool 200 also comprises a handle 204 allowing manual handling. It is therefore a manual dismantling tool.

When the air supply skirt 6 is to be removed, the tool 200 is partially introduced into the sleeve 64, by axial translation in the direction of the arrow T′ in FIG. 7, then this tool is rotated about the longitudinal axis A2, in the direction of the arrow R in FIG. 7 to bring the reliefs 202 and 648 into engagement. The reliefs then bear against the endpiece 12 and the permanent magnet 14. Given the inclined nature of the reliefs 648, the rotation of the tool 200 in the direction of the arrow R has the effect of exerting an axial separation force on the reliefs 648 and the endpiece 12, which induces the rear edge 642 of the sleeve 64 to move away relative to the permanent magnet 112. The magnetic hooking force is thus greatly reduced in intensity, or even eliminated. It is then possible to exert on the handle 204 of the tool 200 an axial force in the direction of the arrow T″ in FIG. 8, in the opposite direction to that of the arrow T′, which makes it possible to extract the air supply skirt 6, against the reduced magnetic force exerted by the magnet 112, or even in the absence of such a force.

According to an alternative of the invention, not represented, it is possible to replace the manual dismantling tool 200 with an automatic dismantling tool, mounted at the end of a robot arm and executing movements according to the arrows T′, R, and T″, as explained above.

Whether using a manual dismantling tool or an automatic dismantling tool, a method for dismantling the air supply skirt 6 from the main body 4 comprises successive steps consisting of
securing the dismantling tool 200 to the sleeve 64, in particular by cooperation of form by means of rotation;
exerting on the dismantling tool an axial force T″ to separate the sleeve 64 vis-a-vis the magnetic hooking device 100A.

Furthermore, the structure of the magneto-pneumatic system 100 of the invention is compatible with fitting the air supply skirt 6 onto the main body 4 by means of a robot. Thus, according to one particular aspect, the present invention allows to automate the mounting and dismantling of an air supply skirt on the main body of an atomizer.

The bowl 8 is not represented in FIGS. 3 to 8. It is positioned in the central opening O6 of the air supply skirt 6 after the latter has been hooked and clamped onto the main body 4, at the end of the step represented in FIG. 6 and using the magnetic force between the magnet 14 and the ferromagnetic body of the bowl. The bowl 8 is removed before the tool 200 is used.

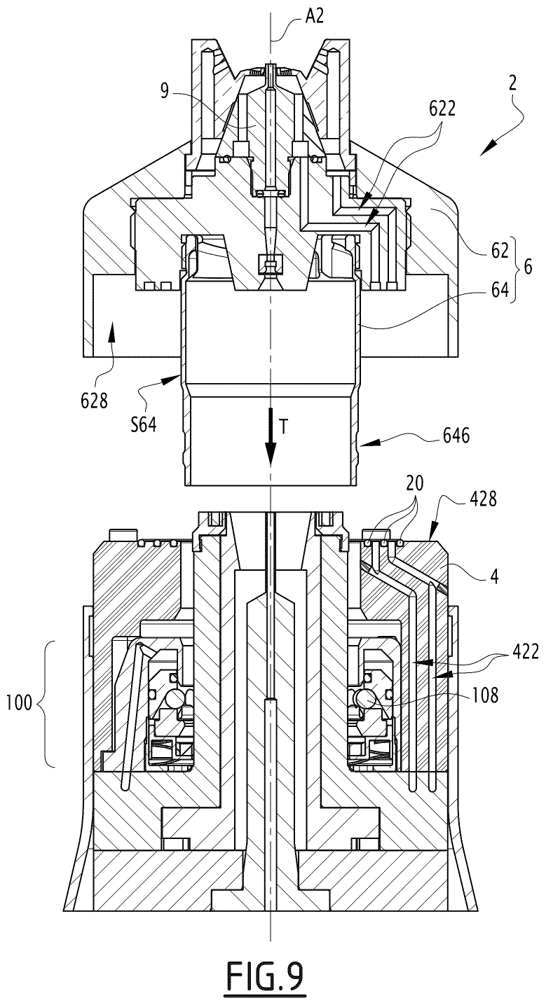

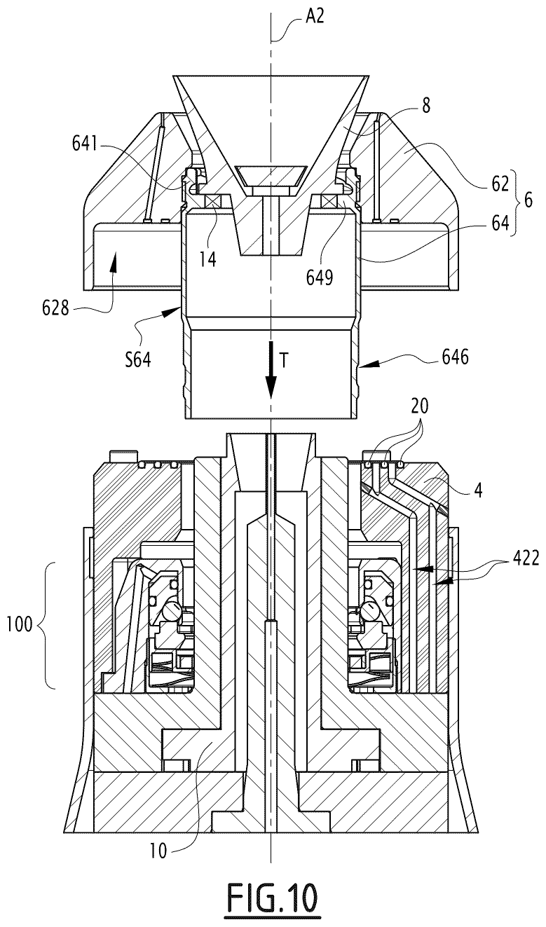

In the second and third embodiments of the invention represented in FIGS. 9 and 10, elements similar to those in the first embodiment has the same references. In the following, if a reference is used in the description without being mentioned on one of FIGS. 10 and 11, or if a reference is mentioned on one of these figures without being mentioned in the description, it relates to the same element as that having the same reference in the first embodiment.

In the second embodiment, the atomizer 2 is of the pneumatic type, without a rotating bowl comparable to the rotating bowl 8 of the first embodiment. In this embodiment, a spray head 9 is mounted on an air supply skirt 6 which comprises a skirt body 62 and a sleeve 64 comparable to those of the first embodiment. The main body 4 of the atomizer 2 defines the ducts 422 intended to be connected to the ducts 622 provided in the skirt body 62. A magneto-pneumatic system 100, similar to that of the first embodiment, is provided for hooking the air supply skirt 6, already equipped with the spray head 9, onto the main body 4, then exerting, by means of engagement members 108 engaged in a relief 646 of the sleeve 64, a clamping force, which in particular allows the O-rings 20 to be compressed.

In one alternative, not shown, the air supply skirt 6 is mounted and clamped on the main body 4 before mounting the spray head 9 on the air supply skirt. According to another alternative, the spray head 9 is mounted on the main body 4 before the air supply skirt 6 is mounted and clamped on the main body 4.

The shape of the main body 4 represented in FIG. 9 is not limited. In particular, this main body 4 does not necessarily comprise a rotor and a fixed part forming a stator.

In the third embodiment, the annular permanent magnet 14 is carried by the air supply skirt 6, more particularly by the sleeve 64, at its front end 641. In particular, the bowl 8 bears on an internal radial collar 649 of the sleeve 64, in which the magnet 14 is integrated.

Thus, a sub-assembly consisting of the air supply skirt 6 and the bowl 8 can be mounted on or dismantled relative to the main body 4 as a unit.

The atomizer 2 of this third embodiment is equipped with a magneto-pneumatic system 100 similar to that of the first embodiment.

Alternatively, in the third embodiment, the air supply skirt 6 can be placed in position, hooked and clamped onto the main body 4 in a first step, with the bowl 8 being attached to the air supply skirt in a second step.

In this respect, in the first embodiment, it is alternatively possible to hook and clamp the air supply skirt 6 onto the main body 4 while the bowl 8 is already engaged in the central opening O6 of the air supply skirt.

Alternatively, and irrespective of the embodiment, the atomizer 2 is of the externally charged electrostatic type and comprises a high-voltage unit and charging the electrodes, not represented, configured to raise to a given electrical potential the coating product sprayed by the atomizer 2.

In one alternative, not represented, when the atomizer 2 comprises a spray bowl 8, this can be securely attached to the rotor 10 by means other than magnetic, for example by screwing.

According to another alternative, applicable to all the embodiments, the atomizer is not of the electrostatic type.

According to another alternative, applicable to all the embodiments, during the step in FIG. 4, the edge 642 of the sleeve 64 comes to bear against the support 110 and not against the magnet 112. This also allows a closed magnetic flux of the type of the closed magnetic flux FM represented in FIG. 4 to be created.

Whatever the design, the magneto-pneumatic system 100 can be used automatically, using the magnetic force generated by the permanent magnet 114 and controlling the supply of pressurized air to the variable volume chamber C100 or its discharge by means of valves controlled by an electronic control unit, not represented. Thus, the operation of the magneto-pneumatic system 100 during mounting or dismantling of the air supply skirt 6 can be automated, relieving an operator working in the vicinity of the atomizer 2 and making his work less hazardous.

Whatever the embodiment, the variable volume chamber C100 of the magneto-pneumatic system 100 can, alternatively, be supplied with a pressurized gas other than air.

According to another alternative of the invention, not represented, the variable volume chamber C100 of the system 100 can be supplied with liquid, in particular water, to control the displacement D of the piston 106. In this case, system 100 is a magneto-hydraulic system.

As an alternative applicable to all the embodiments, the O-rings 20 are mounted in grooves arranged on the bottom 628a of the recessed housing 628 and/or the grooves equivalent to the grooves 628c and 628d are provided on the front face 428 of the external part 42 of the main body 4.

The invention is described above in the context of its use for the spraying of liquid coating product. It also applies to the spraying of powder coating material.

Insofar as technically possible, the above-mentioned embodiments and alternatives may be combined.

1. A coating product atomizer comprising:
a main body;
an air supply skirt attached to the main body;
a magnetic attraction means between the magnetic body and the air supply skirt; and
a magneto-pneumatic or magneto-hydraulic system which includes:
a magnetic device for hooking the air supply skirt to the main body; and
a pneumatic or hydraulic mechanism for locking and clamping the air supply skirt to the main body.

2. The coating product atomizer according to claim 1, wherein:
the magnetic hooking device is configured to exert, between the air supply skirt and the main body, an axial magnetic force, parallel to a longitudinal axis of the atomizer, with a first intensity;
wherein the pneumatic or hydraulic clamping mechanism is configured to exert, between the air supply skirt and the main body, an axial mechanical force, parallel to the longitudinal axis of the atomizer, with a second intensity, and wherein the second intensity is strictly greater than the first intensity.

3. The coating product atomizer according to claim 2 further comprising:
seals arranged between the air supply skirt and the main body, wherein the seals, compressed by the mechanical force exerted by the pneumatic or hydraulic clamping mechanism, isolate the air flow ducts arranged in the main body and in a body of the air supply skirt vis-a-vis the outside of the atomizer.

4. The coating product atomizer according to claim 1, wherein the air supply skirt comprises a sleeve made of a ferromagnetic material, centered on a longitudinal axis of the atomizer in the mounted configuration of the air supply skirt on the main body, and provided with at least one external relief for cooperation with the pneumatic or hydraulic clamping mechanism.

5. The coating product atomizer according to claim 4, wherein the magnetic hooking device comprises a permanent magnet mounted on a support, movable parallel to the longitudinal axis of the atomizer, and wherein the permanent magnet on the support is configured to receive in abutment one end of the sleeve opposite a skirt body.

6. The coating product atomizer according to claim 4, wherein the pneumatic or hydraulic clamping mechanism comprises a piston, movable parallel to the longitudinal axis of the atomizer, inside a chamber selectively supplied with pressurized fluid, and wherein the piston is equipped with engagement members for engagement with the external relief of the sleeve.

7. The coating product atomizer according to claim 6, wherein:
the engagement members are balls; and
the piston comprises cam surfaces inclined relative to the longitudinal axis of the atomizer; and
wherein when the air supply skirt is hooked onto the main body by the magnetic hooking device and when the piston is displaced toward an end of the sleeve opposite a body of the air supply skirt, the cam surfaces exert on the balls an engagement force in the external relief of the sleeve, the engagement force being centripetal relative to the longitudinal axis.

8. The coating product atomizer according to claim 6 further comprising at least one elastic member for returning the piston toward a position in which the engagement members are disengaged from the external relief of the sleeve.

9. The coating product atomizer according to claim 1 further comprising a tool for dismantling the air supply skirt, the dismantling tool comprising reliefs for hooking onto the air supply skirt and being configured to exert on the air supply skirt a force parallel to a longitudinal axis of the atomizer and opposite to a magnetic force exerted on the air supply skirt by the magnetic hooking device.

10. A method for mounting an air supply skirt on a main body of the coating product atomizer of claim 1, the method comprising at least successive steps consisting of:
a) introducing a sleeve of the air supply skirt into a central housing of the main body until the magnetic hooking device exerts a magnetic hooking force on the air supply skirt on the main body; and
b) supplying the pneumatic or hydraulic clamping mechanism with pressurized fluid until the pneumatic or hydraulic clamping mechanism exerts a mechanical force to clamp the air supply skirt to the main body.

11. The method of claim 10, wherein:
the air supply skirt of the coating product atomizer comprises a sleeve made of a ferromagnetic material, centered on a longitudinal axis of the atomizer in the mounted configuration of the air supply skirt on the main body and provided with at least one external relief for cooperation with the pneumatic or hydraulic clamping mechanism;
the pneumatic or hydraulic clamping mechanism comprises a piston, movable parallel to the longitudinal axis of the atomizer, inside a chamber selectively supplied with pressurized fluid;
the piston is equipped with engagement members for engagement with the external relief of the sleeve;
the engagement members are balls;
the piston comprises cam surfaces inclined relative to the longitudinal axis of the atomizer;
when the air supply skirt is hooked onto the main body by the magnetic hooking device and when the piston is displaced toward an end of the sleeve opposite a body of the air supply skirt, the cam surfaces exert on the balls an engagement force in the external relief of the sleeve, this force being centripetal relative to the longitudinal axis; and
during step b), the piston displaces the balls in the direction of a bottom of the central housing, driving the sleeve with the balls engaged in the external relief.
